(19) United States
(12) Patent Application Publication
(10) Pub. No.: US 2011/0032810 A1
(43) Pub. Date: Feb. 10, 2011

(54) MASTER DEVICE

(76) Inventors: Gunter Beulich, Dresden (DE); Petra Junker, Dresden (DE); Ekkehart Kaendler, Hermsdorf (DE); Wolfhart Bosien, Dresden (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/602,872

(22) PCT Filed: Jun. 6, 2008
(86) PCT No.: PCT/EP08/04536

§ 371 Date: Oct. 7, 2010

(30) Foreign Application Priority Data
Jun. 6, 2007 (DE) 10 2007 026 302.5
Jan. 14, 2008 (DE) 10 2008 004 254.4
Apr. 10, 2008 (DE) 10 2008 018 222.2

(51) Int. Cl. G11B 7/00; G11B 7/26; B23P 19/00

(52) U.S. Cl. 369/100; 369/272.1; 29/729; G9B/7; G9B/7.194

(57) ABSTRACT

The invention relates to a master device which can be used in a method for producing a recording medium, a substantially spirally or concentrically running main track structure and at least one substantially spirally or concentrically running secondary track structure being formed on the master device, the secondary track structure being arranged on at least one side of the main track structure, the secondary track structure having discontinuities varying an optically detectable surface texture of the recording medium in such a way that at least first auxiliary information is represented on the recording medium.

The present invention relates to a master device which can be used in a method for producing an optical recording medium, a device for producing this master device, a method for producing this master device, an optical recording medium and a method for producing the optical recording medium.

The invention is described with respect to scanning an optical recording medium by electromagnetic radiation with a wavelength corresponding to visible light. It is noted, however, that for scanning a recording medium, also electromagnetic radiation with a significantly shorter or longer wavelength is suitable. In these cases, given dimensions can change.

Optical recording media are produced by a multi-level process, using a master device. On the master device, information in the form of main track and secondary track structures is stored, which is transferred to the recording media as main and secondary tracks, commonly known as a track.

With optical recording media, the preformed track is formed either as an indentation or an elevation compared to the surrounding surface, the so-called “land”. A track being formed as an indentation can at least partially be filled with a material whose reflection and/or transmission properties are reversibly or irreversibly changeable by irradiation of light of a predetermined intensity and wavelength, preferably laser light.

In the first place, the preformed track serves the purpose that data can be recorded in it by an information recording device. This takes place by a predetermined change of a first property of the track, preferably such as the reflection or transmission properties of certain areas of the track. These changes are optically detectable and thus readable by any commercial optical information recording and/or playback device. The areas of the track in which a predetermined optical change is made are called main data pits.

Yielding a storage capacity of such recording media as high as possible requires dimensions of the main data pits and the surfaces lying in between, usually called “land”, as small as possible. In order to keep the accuracy requirements for the mechanical components of a corresponding information recording and/or playback device in a practicable range, the track normally also serves the purpose of tracking the scanning light beam of the information recording and/or playback device by detecting second optically detectable properties.

In this way, the required positioning precision of the read and write light beam can be achieved even at a high surface density of the data structures to be written.

Often, the track is provided with third optically detectable properties, from which information about the linear recording velocity with which the data structures are preferably to be written can be derived. For instance, the track can be deflected sinusoidally around the middle of the track with a predetermined wavelength. For a disc-shaped recording medium, the rotation frequency of the motor rotating this recording medium, for example, can be controlled using this wavelength.

In certain recording media in the prior art, a track is provided with fourth optically detectable properties. For positioning the read and write head—in particular above an unrecorded recording medium—, auxiliary information containing a consecutive address code is prerecorded in the track with these recording media.

The documents EP 0 265 695 B1 and EP 0 325 330 B1 describe recording media for which the wavelength of the track wobbling is changed depending on the auxiliary information.

Preferably, optical information recording and/or playback devices accept an ever-increasing number of different recording media of different recording materials which sometimes require different recording methods and/or recording velocities. Therefore, corresponding different write parameters specific to the respective recording medium are required. For this reason, in certain forms of known recording media, the prestored auxiliary information of the track is enhanced by control codes which can contain, amongst others, the write parameters specified for the respective recording medium.

The European Patent EP 0 397 238 B1, for instance, claims a record carrier for which the auxiliary information consisting of address and control codes is recorded in the preformed track by means of a preformed track modulation containing a radial, sinusoidal modulation either by track wobbling or change of the track width.

It is a disadvantage of record carriers according to EP 0 397 238 B1 that the data density of the auxiliary information which can be placed into the track by such a modulation is severely constrained by the requirement that the error-free detectability of the data structures to be recorded must be influenced as little as possible.

From the published patent applications DE 10 2005 027 222 A1 and DE 10 2005 018 089 A1 by the applicant, a method is known in which the auxiliary information is represented by means of a deflection being orthogonal to the respective direction of the track.

It is a disadvantage of record carriers according to DE 10 2005 027 222 A1 and DE 10 2005 018 089 A1 that the auxiliary information is placed into the track, which can cause an impact on the data structures to be recorded.

Therefore, it is the object of the present invention to create a master device enabling a recording medium to be created that circumvents the disadvantages mentioned above, being as compatible with existing recording media as possible. This object is achieved by the subject matter of claim 1.

It is a further object of the invention to create a device for producing a recording medium according to the invention. This object is achieved by the subject matter of claim 7.

Moreover, it is an object of the invention to make a device for producing a master device available. This object is achieved by the subject matter of claim 17.

The recording medium according to the invention and the device for producing the recording medium and the master device are the subject matter of claims 16, 27 and 28, respectively.

Preferred embodiments and extensions as well as amendments of methods are the subject matter of the dependent claims.

The master device according to the invention has a main track structure running substantially spirally or concentrically and at least one secondary track structure running substantially spirally or concentrically.

In the sense of the invention, the main track structure is a track structure by means of which a main track is formed on an optical recording medium produced according to the invention. The main track serves for guiding at least one beam of an information recording and/or playback device. Along the main track, areas are arranged at least sectionwise in which a multitude of main data pits can be formed. The areas of the track in which a predetermined optical change is made are called main data pits in the context of the present invention.

In the sense of the invention, by a secondary track structure a track structure is meant by means of which a secondary track is formed on an optical recording medium produced according to the invention. Here, the secondary track has a substantially constant distance to the center of the main track. In particular, the geometrical center of the secondary track has a distance to the geometrical center of the main track which is substantially constant.

In a preferred embodiment of the invention the geometrical centerline of the secondary track structure has a radial distance of TP/N from the geometrical centerline of the main track structure, where TP denotes the track distance between neighboring main track structures and N is a number which is preferably between 8/3 and 12/3.

In a preferred embodiment the secondary track structure has a smaller width than the main track structure.

In a preferred embodiment the secondary track structure has a smaller depth than the main track structure.

In a preferred embodiment the first auxiliary information contains application and/or control and/or security data.

In a preferred embodiment the second auxiliary information contains application and/or control and/or security data.

According to the invention, the secondary track structure is arranged on at least one side of the main track structure and can have discontinuities which vary an optically detectable surface texture of the recording medium in such a way that at least first auxiliary information is represented on the recording medium. By this arrangement, it is possible on the one hand to reduce the influence of the secondary track structure on the main track structure and, on the other hand, to reduce the place required by the track structure which, in turn, leads to a higher recording density.

The optically detectable surface textures in the sense of the invention are reflection and/or transmission properties of the optical recording medium which are reversibly or irreversibly changeable by light irradiation of a predetermined intensity, preferably laser light.

In the sense of the invention, an optical recording medium is a disc with a diameter of 110 to 130 mm, preferably 115-125 mm, more preferably 120 mm. However, smaller diameters like e.g. 80 mm are possible as well. Furthermore, the optical recording medium has a given surface level on one side and/or on both sides being substantially constant on the whole surface of a side.

The secondary track structure can create pilot marking areas with pilot marks on the recording medium in which auxiliary information is deposited.

In the sense of the invention, pilot marks mean areas in the secondary track in which predetermined optical/optically detectable changes are made which can serve as auxiliary information.

For example, these secondary track structures with pilot marks contained in them can be arranged in the reading direction on either side of a main track structure or just on one side of the main track structure. A common arrangement of photodiodes is formed in such a way that the positions of the photodiodes are symmetrical with respect to a centerline in the running direction of the tracks. Four central diodes are dedicated to detecting the main track structure. More on the outside, two groups of two photodiodes each are arranged, called secondary track diodes in the following, which serve for detecting the secondary track structures. The signals of these secondary track diodes are connected by the controller of the detector in such a way that even with the presence of a just one-sided secondary track structure the pilot marks can be detected in a reasonable way.

In a further preferred embodiment of the master device, the secondary track structure is formed just on one side of the main track structure.

In a preferred embodiment of the master device, the optically detectable property at the recording medium is an indentation of the surface between two discontinuities which is substantially arranged in the direction of the track.

In a preferred embodiment of the master device, an indentation of the surface between two discontinuities which is arranged substantially in the direction of the track and which can be optically detected at a recording medium has a variable depth and/or width, which is thus not constant along the total length of the indentation.

In a preferred embodiment of the master device, an indentation of the surface between two discontinuities which is substantially arranged in the direction of the track and which can be optically detected at the recording medium is not clearly delimited, but has a substantially smooth transition into at least one (not indented) discontinuity.

Here, smooth means, in the sense of the invention, that the elevation profile of the secondary track structure is substantially continuous. In a preferred embodiment of the master device according to the invention, the variation in height and/or depth of the secondary track structure is formed in such a way that the light intensity of the reflected secondary beam generates preferably sinusoidal voltage characteristics, which serve for tracking, in the secondary beam photodiodes.

In a further embodiment of the master device according to the invention, a variation of the track width of the secondary track (similarly to the variation of the height and/or depth of the secondary track) generates preferably sinusoidal voltage characteristics in the secondary beam photodiodes.

Substantially sinusoidal voltage characteristics have the advantage, as opposed to rectangular or trapezoid voltage characteristics, that tracking signals are free of harmonics as much as possible. In this way, the required bandwidth of the tracking signals is reduced, which is proven by a Fourier transformation.

By a master device in the sense of the invention, a master for recording media, preferably made of glass, is meant on which the main track structure and the secondary track structure are formed. Using this master device, optical recording media are produced in subsequent steps.

In a preferred embodiment of the master device, the optically detectable property at a recording medium is a surface texture between two discontinuities which is substantially arranged in the direction of the track and which is substantially punctiform.

In the sense of the invention, punctiform means an extension in the direction of the track of 1-20 μm, preferably 3-15 μm, more preferably 5-10 μm.

Here, by the direction of the track, in the sense of the invention, the direction is meant in which the optical recording medium is written to or read from, respectively.

In the sense of the invention, a discontinuity is a change in the surface texture in the direction of the track.

In a preferred embodiment of the master device, the main track structure is at least sectionwise, but in particular completely, formed as a surface texture being homogenous in the direction of the track.

In the sense of the invention, an area which exhibits substantially no change in surface texture along the direction of the track is called homogenous.

In a preferred embodiment of the master device, the main track structure is formed at least sectionwise as a surface texture being substantially punctiform in the direction of the track.

In a preferred embodiment of the master device, the secondary track structure is formed at least sectionwise as a surface texture which is homogenous in the direction of the track.

In a preferred embodiment of the master device, the secondary track structure is formed at least sectionwise as a surface texture which is substantially punctiform in the direction of the track.

In a preferred embodiment of the master device, the secondary track structure has a surface texture which varies an optically detectable surface texture of a secondary track structure of the recording medium in such a way that second auxiliary information is represented on the recording medium.

The optically detectable properties can be assigned to the bits of a channel code, for instance of the biphase mark code. Here, for example, an above-mentioned detectable property represents a logical “1” and a discontinuity a logical “0” of the channel code. In this process, a logical “0” of the digital code for the auxiliary information is assigned to either a “00” or a “11” of the biphase mark code, and a logical “1” of the digital code of the auxiliary information to either a “01” or a “10” of the biphase mark code in such a way that no more than two consecutive zeros or ones occur in the biphase mark code.

In a preferred embodiment of the master device, the main track structure is formed without a track modulation.

In the sense of the invention, by track modulation a change of the track width being orthogonal to the direction of the track and/or a change of the center of the track around a geometrical mean value is meant. Here, the track width can be varied around a constant value and/or around a variable value.

In a further preferred embodiment of the master device, the main track structure is formed with a track modulation.

Master device according to at least one of the preceding claims, characterized in that the track modulation is a radial, substantially sinusoidal track modulation.

In a further preferred embodiment of the master device, the track modulation is a monofrequent track modulation.

In a further preferred embodiment of the master device, the track modulation is a track width modulation.

In a further preferred embodiment of the master device, the track modulation represents further auxiliary information.

In a further preferred embodiment of the master device, the secondary track structure is substantially arranged in a constant radial distance to the geometrical center of the main track structure.

The device according to the invention for producing a master device has at least one first optical means for recording a main track structure by means of a first light beam on a base carrier, an electrooptical beam deflector through which the first light beam runs and/or a second optical means for recording a secondary track structure by means of a second light beam on the base carrier. According to the invention, the second light beam runs through a second electrooptical beam deflector which adjusts a substantially constant radial distance between the center of the main track structure and the secondary track structure by means of an applied control signal, and a secondary track structure generator controls the second light beam at least depending on a first and/or second auxiliary information. As a compensation for a possible unevenness of a master device, both light beams run through a control unit which focuses these light beams in order to yield a uniform light spot on the base carrier.

In a further device according to the invention for producing a master device, a first light beam for recording a main track structure is directed onto the base carrier without means for steering the beam. Before impinging on this base carrier, the first light beam, as above, runs through this focussing control unit for compensating a possible unevenness of the master device. A second light beam runs through, as described above, an electrooptical beam deflector and is joint before this focussing control unit with this first light beam by subsequent beam steering means. In this way, an electrooptical beam deflector and beam steering means for this first light beam can be dispensed with.

In a further preferred embodiment of the device, a track width modulation of the first light beam is carried out by means of the electrooptical beam deflector.

In a further preferred embodiment of the device, the energy of the light beam for generating the structure needed for the secondary track is varied, yielding a variation of the height and/or the depth and/or the width of the structures. A variation of the energy of the light beam is, for instance, achieved by operating the light beam with a suitable change signal superimposed on a constant power.

In a further preferred embodiment of the device, the position of the laser focal points on the master are calculated by means of an image processing unit, and the position information is fed to at least one optical deflector.

In a further preferred embodiment of the device, the laser focus of both beams adjusted on the master is displayed on a measuring camera. The image information derived from this is fed to at least one control computer and/or at least one image processing unit. In this way, the position of the laser focal points on the master can be calculated and/or adjusted and/or readjusted. In this way, substantially a measure for the distance of the secondary beam to the main beam is determined which is used for controlling an optical deflector and/or a control computer. The detected actual value of the distance is compared to a reference value and is exactly readjusted in-line if necessary.

In a further preferred embodiment of the device, two measuring cameras are used on which the laser focus of both beams adjusted on the master are displayed. In this way, the image information needed for the control computer and the image processing unit are determined independently of each other and are separately fed to at least one control computer and at least one image processing unit.

In a further preferred embodiment of the device, the first light beam is controlled by a main track generator.

In a further preferred embodiment of the device, the main track generator outputs a constant signal and an alternating signal for controlling the first light beam.

In a further preferred embodiment of the device, the main track generator outputs an analog signal for controlling the electrooptical beam deflector.

In a further preferred embodiment of the device, the second light beam is controlled by means of a secondary track generator.

In a further preferred embodiment of the device, the secondary track generator outputs a constant signal and an alternating signal for controlling the second light beam.

In a further preferred embodiment of the device, the secondary track generator outputs a DC and/or an AC signal for controlling the second electrooptical beam deflector.

In a further preferred embodiment of the device, the control signal fed to the second beam deflector is a voltage signal with a DC component.

In a further preferred embodiment of the device, the analog signal output by the main track generator for controlling the electrooptical beam deflector is fed to the electrooptical beam deflector.

The recording medium according to the invention is obtained by a producing method or by a means of producing a recording medium, respectively, using one of the master devices described above.

A method according to the invention for producing a master device has at least one of the following steps: exposing a base carrier with a main track structure by means of a first light beam, a photoresist being applied to the surface of the base carrier; exposing the base carrier with a secondary track structure by means of a second light beam; developing the exposed photoresist; removing the exposed or unexposed photoresist from the base carrier; applying a first metallic coating to the base carrier; and/or applying a second metallic coating to the base carrier.

### EMBODIMENTS

Further advantages and embodiments of the present invention will be apparent from the accompanying drawings, in which:

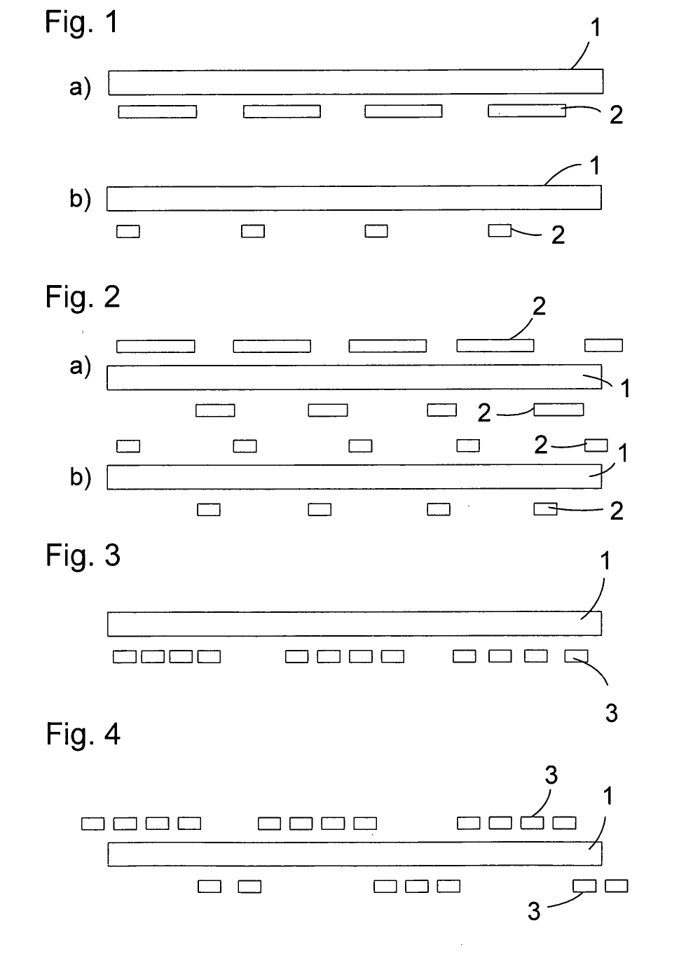

FIG. 1 shows two examples for the arrangement of a main track and a secondary track structure on a master device,

FIG. 2 shows two further examples for the arrangement of a main track and a secondary track structure,

FIGS. 3-16 show further examples for the arrangement of a main track and a secondary track structure,

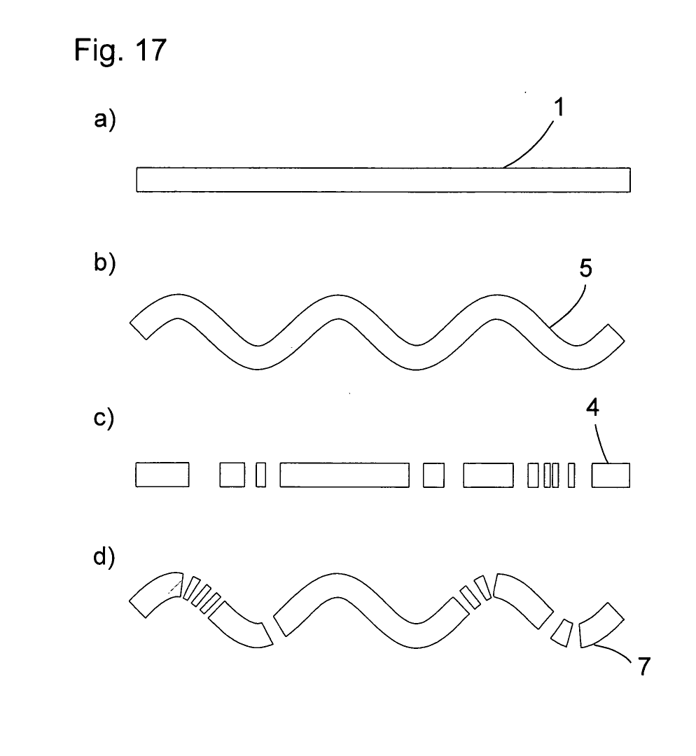

FIG. 17 shows four examples for the formation of the main track structure,

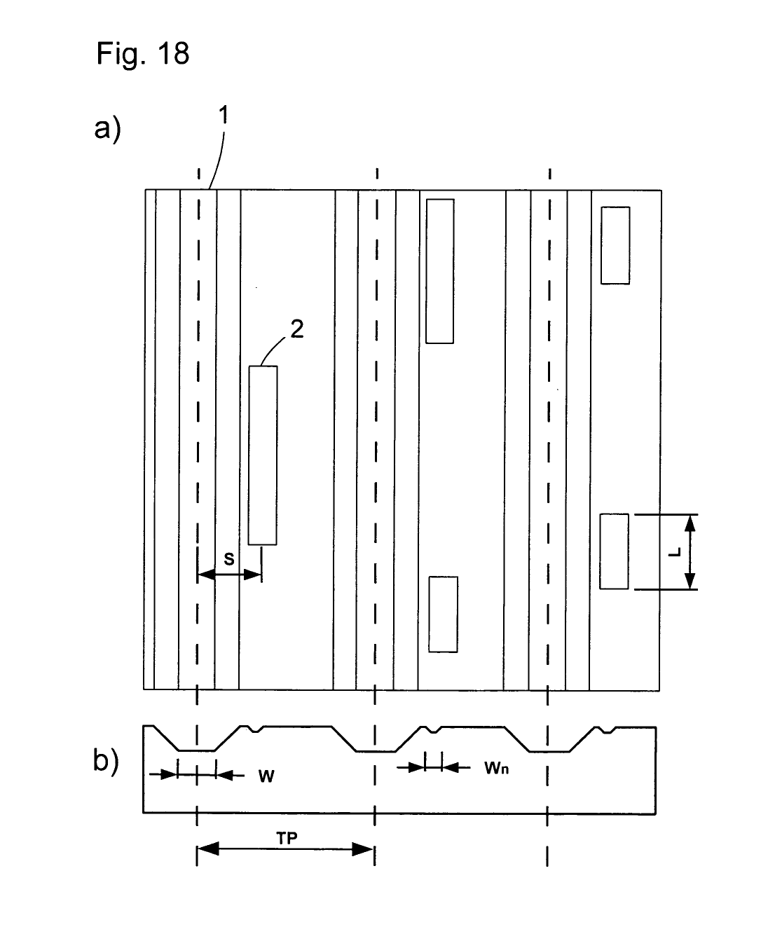

FIG. 18 shows a schematic representation of the arrangement of the main track and the secondary track structure and a track structure profile,

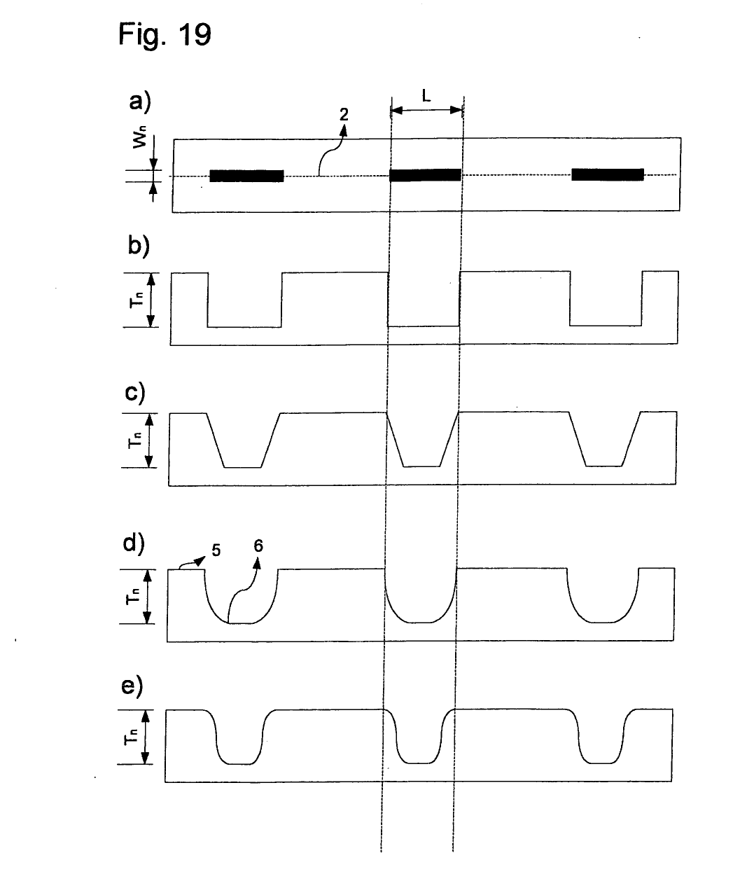

FIG. 19 shows examples for possible structure profiles of the secondary track structure,

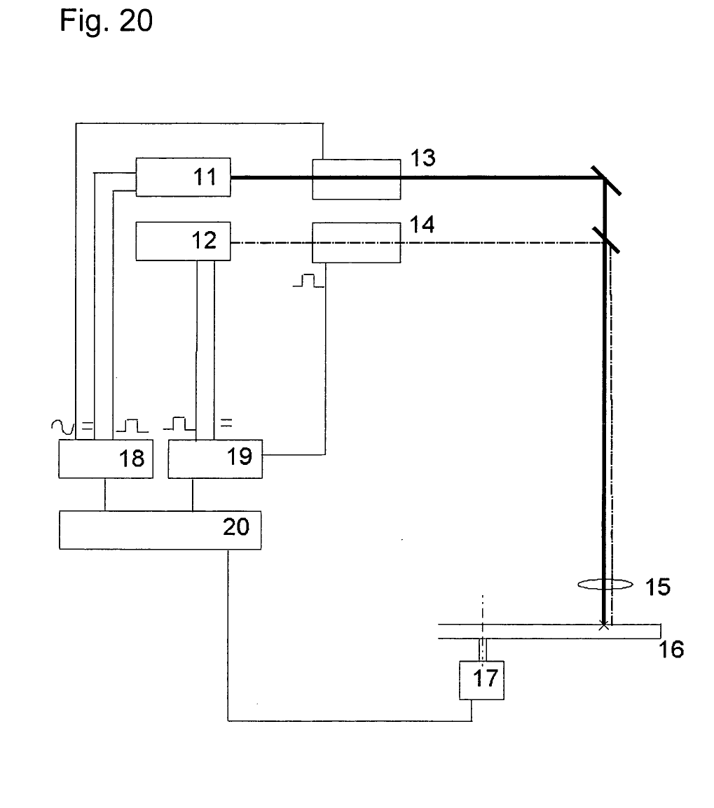

FIG. 20 shows a schematic representation of the device for producing a master device,

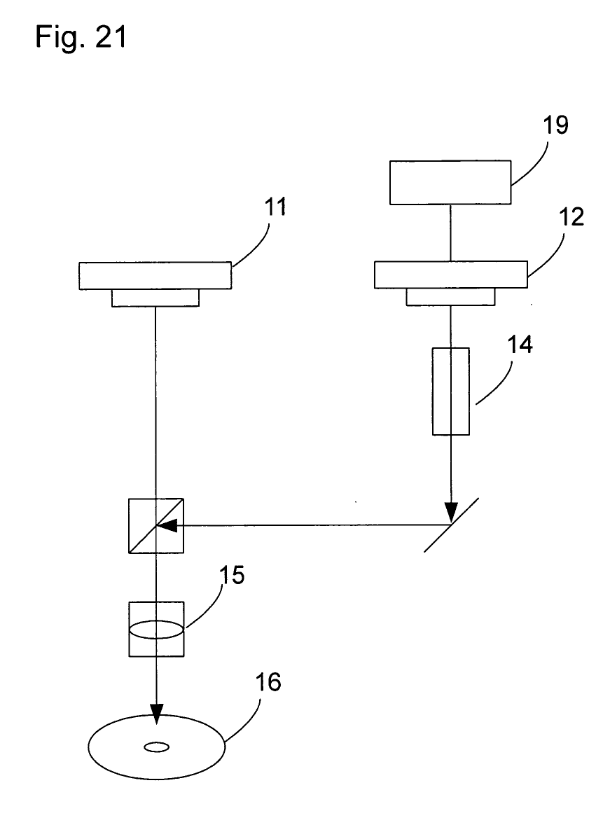

FIG. 21 shows a schematic representation of a further device for producing a master device with a linearly guided first light beam as a cheaper variant of the device from FIG. 20,

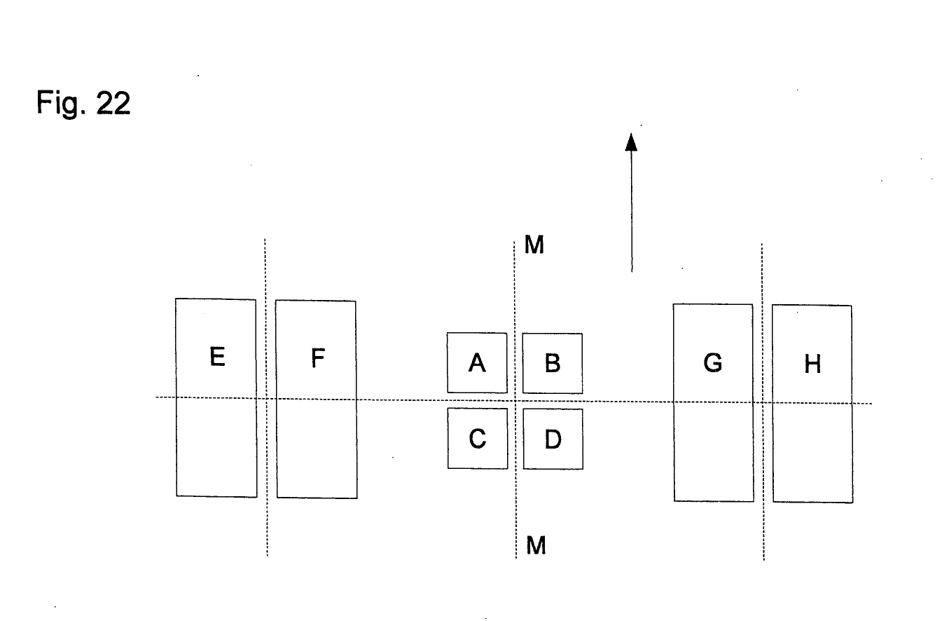

FIG. 22 shows a representation of the arrangement of the central photodiodes A, B, C, D as well as the photodiodes of the secondary beams E, F, and G, H, respectively, of a common playback device/detector.

FIG. 1 shows two examples for the arrangement of the main track structure 1 and the secondary track structure 2 on the master device. In FIG. 1a, the main track structure 1 is formed as a surface texture being substantially homogenous in the direction of the track. The secondary track structure 2 is also formed as a surface texture being substantially homogenous in the direction of the track and is arranged on one side of the main track structure 1, the secondary track structure 2 having discontinuities. The secondary track structure 2 can also be arranged on the opposite side of the main track structure 1.

The secondary track structure 2 shown in FIG. 1b substantially corresponds to the secondary track structure 2 in FIG. 1a, the discontinuities in the secondary track structure 2 in the direction of the track being larger than the surface texture of the secondary track structure 2 being substantially homogenous in the direction of the track.

The main track structure 1 corresponds to the main track on an optical recording medium, and the secondary track structure 2 corresponds to the secondary track, or pilot track, on an optical recording medium. The distances between the main track structures 1 are preferably chosen as being substantially constant in order to facilitate the positioning of the write and read head above an optical recording medium.

Furthermore, the secondary track structure 2 is substantially arranged in a constant distance to the center of the main track structure 1. Particularly preferably, the distance between the main structures 1 and between main track structure 1 and secondary track structure 2 are chosen to be minimum in order to maximize the information density on the resulting recording medium.

FIGS. 2a and 2b substantially correspond to FIGS. 1a and 1b, the secondary track structure 2 being arranged symmetrically on either side of the main track structure 1. Furthermore, in FIG. 2a, the secondary track structure 2 is arranged sectionwise alternatingly on opposite sides of the main track structure 1.

The arrangement of the secondary track structure 2 alternatingly on opposite sides of the main track structure 1 is advantageous in as much as a DC-free tracking signal can be obtained from the optical detection of the secondary track on the recording medium, in particular with substantially equally distributed numbers of secondary track structures 2 on either side of the main track structure 1.

In FIG. 3, the secondary track structure 3 is formed as a surface texture which is substantially arranged in the direction of the track and which is substantially punctiform and is arranged on one side of the main track structure 1.

FIG. 4 shows the secondary track structure 3, which is symmetrically arranged on either side of the main track structure 1.

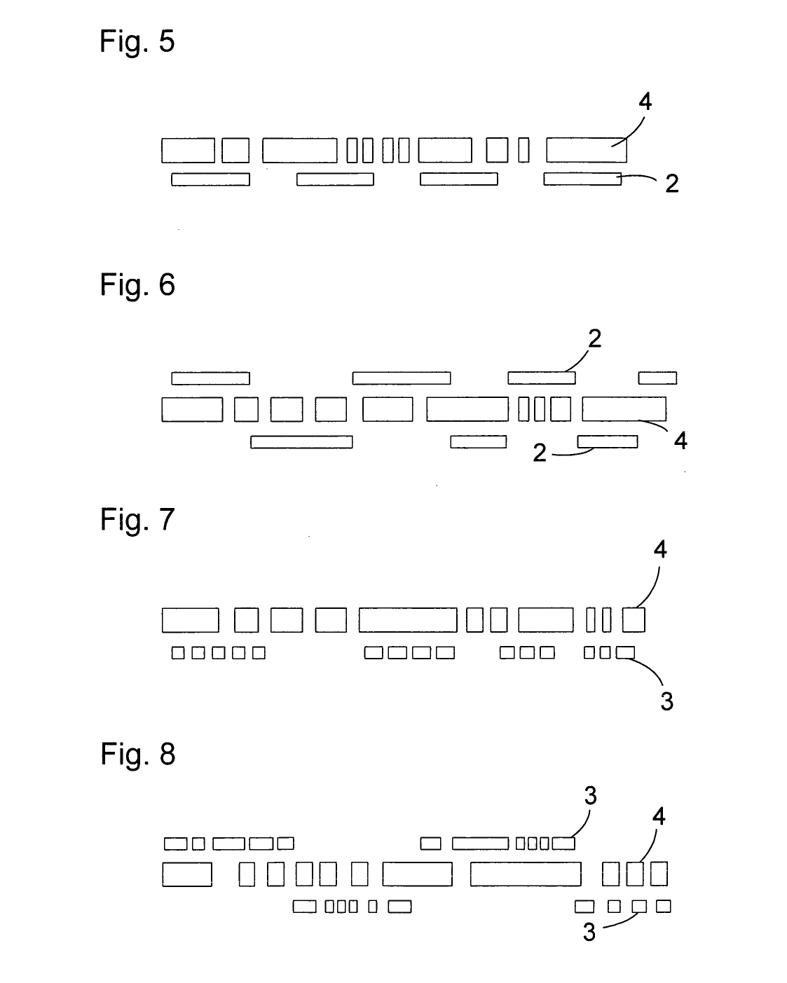

In FIGS. 5 to 8, the main track structure 4 is formed as a surface texture with discontinuities being substantially homogenous in the direction of the track. Here, the secondary track structures 2, 3 can be formed as a surface texture being substantially homogenous in the direction of the track (FIGS. 5 and 6) or as a surface texture being substantially punctiform (FIGS. 7 and 8). In FIGS. 5 and 7, the secondary track structures 2, 3 are arranged on one side of the main track structure 4. In FIGS. 6 and 8, the secondary track structures 2, 3 are arranged symmetrically on either side of the main track structure 4.

The discontinuities in the main track structure 4 can be regular or irregular, or they exhibit periodic patterns. By means of the discontinuities in the main track structure 4, it is possible to integrate auxiliary information into the main track structure and, in this way, to further increase the information density on the recording medium.

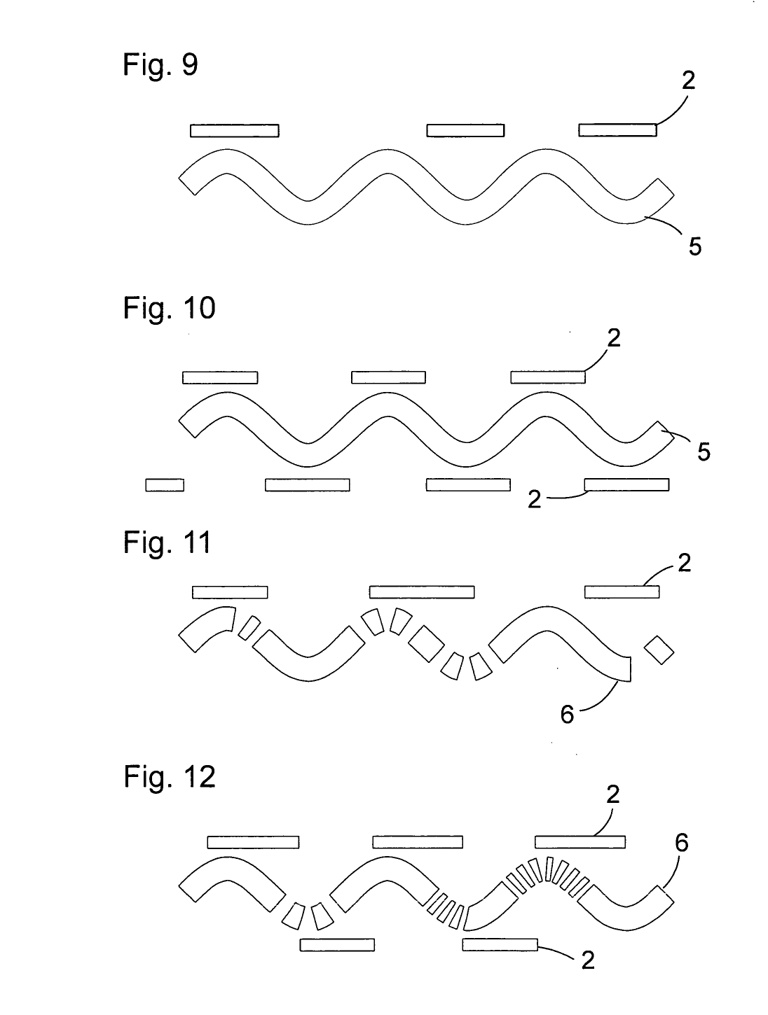

FIGS. 9 and 10 substantially correspond to FIGS. 1 and 2, the main track structure 5 being a surface texture which is substantially homogenous in the direction of the track and which is monofrequently modulated.

FIGS. 11 and 12 substantially correspond to FIGS. 9 and 10, the main track structure 6 being a surface texture which is substantially homogenous in the direction of the track and which is monofrequently modulated, the main track structure 6 having discontinuities.

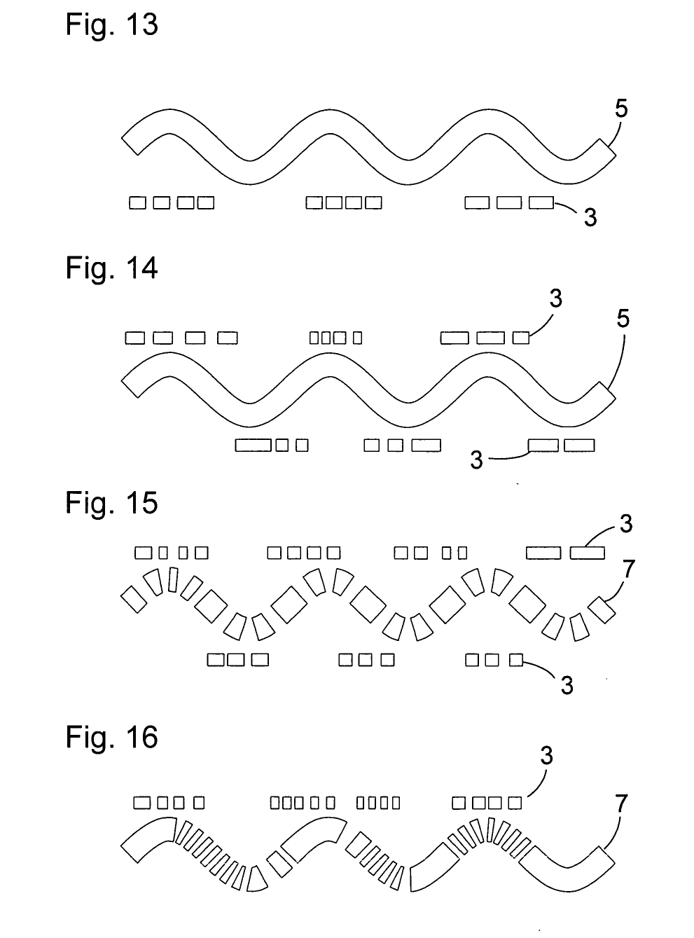

FIGS. 13 to 16 substantially correspond to FIGS. 9 to 12, with the difference that the secondary track structure 3 is a surface texture which is substantially arranged in the direction of the track and which is substantially punctiform.

FIG. 17 again shows four different possible embodiments of the form of the main track structures 1, 4, 5 and 7.

FIG. 18 shows a schematic representation of the arrangement of the main track and secondary track structure as a view from above (FIG. 18a) and a cross-section of the track structure (FIG. 18b) of the master device.

The main track structure 1 preferably has a width W of 200-800 nm, more preferably of 400-600 nm, even more preferably 550 nm. The effective depth TH of the main track structure is preferably between 80 and 130 nm, more preferably between 90 and 120 nm, even more preferably 105 nm. The distance TP between neighboring main track structures 1 is preferably 1000-2000 nm, more preferably 1600 nm. Furthermore, the main track structure 1 has a slope angle between a perpendicular to the substantially flat surface of the master device and the slope of the main track structure 1 of preferably 30°-50°, more preferably 40°.

The secondary track structure 2 preferably has a width Wn of 100-400 nm, more preferably of 200-300 nm, even more preferably 250 nm. The effective depth TN of the secondary track structure is preferably between 25 and 75 nm, more preferably between 40 and 60 nm, even more preferably 50 nm. The distance S between main track structure 1 and secondary track structure 2 is preferably 350-600 nm, more preferably 450-550 nm, even more preferably 500 nm.

Furthermore, the length L of the secondary track structure 2 in the direction of the track is preferably between 10 and 60 μm.

The radial distance S (preferably about 400-600 nm) of the main track structure 1 and the secondary track structure 2 is preferably chosen in such a way that neither a significant overlap with the track nor disturbing crosstalk by neighboring tracks emerges. The length of the pilot marks, i.e. the indentations placed inside the secondary track structure, is variable and approximately corresponds to half the wavelength belonging to the common track wobbling frequency of 22.05 kHz. At a linear velocity of the scanning device relative to the recording medium of about 1.2 m/s, a preferred mean length L of the pilot marks of 54.4/2 μm=27 μm results. The usual frequency shift of ±1 kHz of the modulated track wobbling frequency is realized by a suitable change of length (±ΔL=1.22 μm) of the pilot marks.

Furthermore, the secondary track structure 2 has a slope angle between a perpendicular to the substantially flat surface of the master device and the slope of the secondary track structure running substantially in parallel to the direction of the track of preferably 10°-40°, more preferably 25°.

As shown in FIG. 18, the secondary track structure can also be formed just on one side of the main track structure.

FIG. 19 shows a schematic representation of the secondary track structure 2 as a view from above (FIG. 19a) and four examples of a longitudinal cut of the track structure of the master device (structure profiles FIGS. 19b, 19c, 19d, 19e).

FIG. 19b shows a detail of a structure profile of a secondary track structure 2 in which three pilot marks, i.e. indentations, are placed. The slopes 8 which substantially delimit the indentation in the direction of the track are orthogonal to the substantially flat surface of the master device. The light beam which is reflected by these pilot marks when the secondary track is scanned generates a substantially rectangular output voltage in the secondary track photodiodes E, F, and G, H, respectively, which is, for instance, further processed for tracking purposes. A disadvantage of substantially rectangular signals is, compared to sinusoidal signals, the increased number of harmonics by which the (frequency-dependent) bandwidth of the signal is increased.

FIG. 19c shows a detail of a structure profile of a secondary track structure in which three pilot marks, i.e. indentations, are placed. The linearly extending slopes 8 which substantially delimit the indentation in the direction of the track form a slope angle with a perpendicular of the substantially flat surface of the master device of preferably between 10°-40°, more preferably between 20°-30°. Slanted slopes, for instance, have the advantage with respect to the detection that the output signals of the secondary track photodiodes E, F, and G, H, respectively, have shallower signal slopes as well, generating (compared to rectangular output signals with steep signal slopes) fewer harmonics, resulting in a smaller bandwidth of the signal.

FIG. 19d shows a detail of a structure profile of a secondary track structure in which three pilot marks, i.e. indentations, are placed. Here, the slopes 8 which substantially delimit the indentation in the direction of the track do not extend linearly, but are concave, as depicted. In an alternative embodiment, the slopes can also be convex, however.

FIG. 19e shows a detail of a structure profile of a secondary track structure in which three pilot marks, i.e. indentations, are placed. Here, the slopes 8 which substantially delimit the indentation of the track continuously connect a first surface element 5 of the master device with a second surface element 6 of the master device. When the slopes are formed in a suitable way, substantially sinusoidal output signals are generated in the secondary track photodiodes E, F, and G, H, respectively, which are converted into tracking signals being as harmonic-free as possible. In this way, the bandwidth needed for the signal is minimized as much as possible.

In FIG. 20 an embodiment of a device according to the invention for generating the main track structure 1 and the secondary track structure 2 on the master device 16 is shown. A first monochromatic light source 11, having a laser, for example, generates a first light beam with a first wavelength approximately corresponding to the width of the main track structure. With the help of a main track generator 18, the intensity of the first light beam can be adjusted in such a way that a photoresist provided on the surface of the master device 16 for generating the predetermined geometry of the main track structure 1 is appropriately exposed.

The main track generator 18 can also generate pit structures, i.e. substantially punctiform surface changes, by direct digital control of the laser and can provide an analog signal for generating a track wobble by the electrooptical beam deflector 13.

The thickness of the photoresist preferably corresponds to the depth of the main track structure 1 to be generated. The required beam geometry is generated by means of a beam former 13 and a moveable object lens in such a way that the width of the light spot of the first light beam on the surface of the master device 16 is approximately adjusted to the width of the main track structure 1.

During the exposure, the master device is appropriately moved in parallel to the focus plane of the first light beam so that the light spot on the photoresist describes the desired spiral or concentrically circular main track structure 1. In order to take a possible unevenness of the master device 16 into account, the moveable object lens 15 is continuously readjusted by means of the focus control unit to achieve a uniform light spot.

A second monochromatic light source 12, which can have a laser as well, generates a second light beam with a second wavelength approximately corresponding to the width of the secondary track structure 2. The second light beam 12 can be varied in its intensity with the help of a secondary track structure formatter 19 in such a way that the photoresist on the surface of the master device 16 is appropriately exposed for generating the predetermined geometry of the secondary track structure 2. By turning the laser on and off by an alternating signal provided by the secondary track structure formatter 19, auxiliary information is placed into the secondary track structure 2.

Here, the depth of the secondary track structure 2 relative to the depth of the main track structure 1 can be decreased by choosing the light intensity of the second light beam 12 smaller compared to the light intensity of the first light beam 11.

The depth and/or width of the secondary track can also be continuously changed resulting in an elevation profile as depicted in FIG. 19e, for example. For this purpose, the laser can be controlled by the secondary track structure formatter 19 by means of an appropriate alternating signal superimposed on a constant power.

By means of the beam deflector 14 and the projection lens 15, the light spot of the second light beam 12 is generated on the surface of the master device 16, approximately corresponding in its diameter to the width of the secondary track structure 2. If the beam deflector 14 is additionally controlled by an alternating signal, two secondary track structures 2 can be written symmetrically to the main track structure 1.

A mirror unit enables a centered superimposition of the light beams 11 and 12. The radial distance of the light spots of the second light beam 12 from the light spot of the first light beam 11 on the surface of the master device corresponds to the radial distance of the symmetry lines of the secondary track structure 2 from the symmetry line of the main track structure 1. This distance can be adjusted by setting a DC offset at the electrooptical beam deflector 14.

Furthermore, the device for generating the main track structure and the secondary track structure 2 on the master device 16 has a control computer 20 controlling the main track structure formatter 18, the secondary track structure formatter 19 and at least one turntable 17, on which the master device 16 lies.

FIG. 21 shows a further device according to the invention for generating the main track structure 1 and the secondary track structure 2 on the master device 16. Two monochromatic light sources 11 and 12 generate one light beam each, which are directed with the help of a beam guiding means, having a mirror and a beam collection means, for example, through a lens 15 in the direction of the surface of the master device.

FIG. 22 shows an arrangement of the central photodiodes A, B, C, D, and the photodiodes E, F, and G, H, respectively, for the secondary tracks, as they may be found in a commercial playback device. The arrangement of the photodiodes is symmetric to the centerline M. The included arrow shows the running direction of the tracks. The mathematical connection of the secondary track diodes by the controller of the detector or of the burning device allows for the forming of the secondary track structure even on just one side of the main track structure.

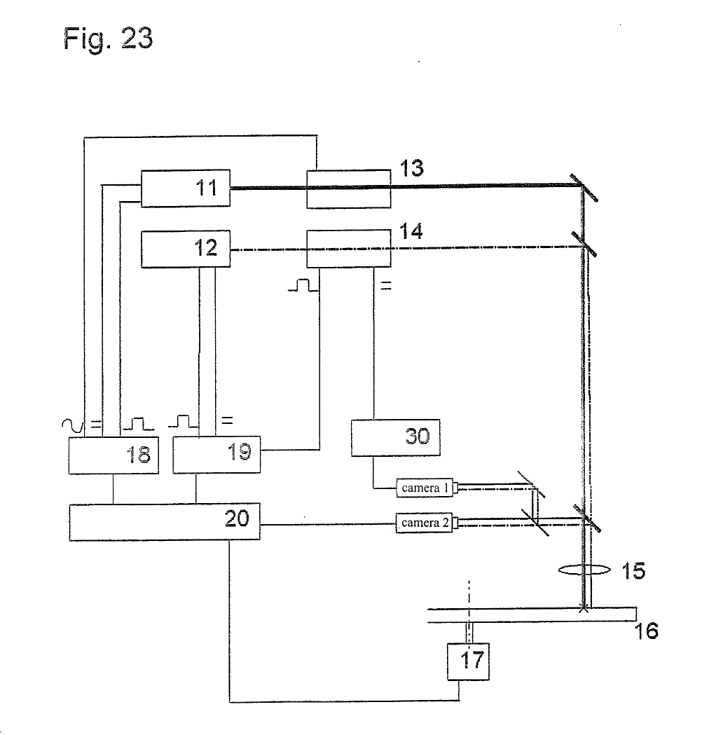

FIG. 23 shows a further device according to the invention for generating the main track structure 1 and the secondary track structure 2 on the master device. As an amendment to the otherwise identical device from FIG. 20, the laser focus of both light beams adjusted on the master is displayed on a first measuring camera and a second measuring camera by decoupling from the present optical path. The image information of the second measuring camera derived from this are fed to the control computer 20 and to the image processing unit 30. In the image processing unit 30, the position of the laser focal points on the master is calculated. Thus, a measure for the distance is determined, which is used for controlling the electrooptical deflector 14. This enables the distance of the secondary track to the main track to be controlled in-line and to be readjusted continuously if necessary.

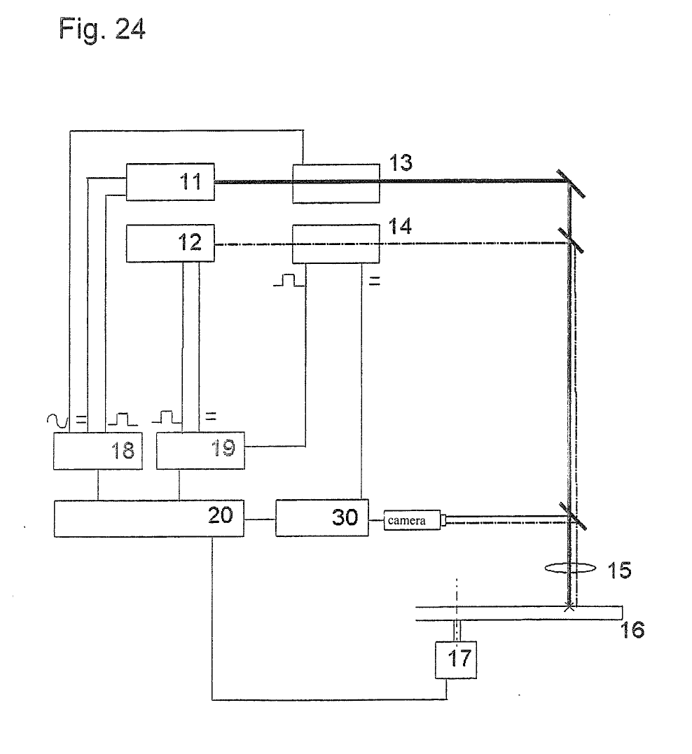

FIG. 24 shows a further device according to the invention for generating the main track structure 1 and the secondary track structure 2 on the master device. Compared to the device from FIG. 23, only one measuring camera is used, the image information of which is fed both to the control computer 20 and to the image processing 30 for further processing.

1. A master device, usable in a method for producing a recording medium, comprising a substantially spirally or concentrically running main track structure and at least one substantially spirally or concentrically running secondary track structure being formed on the master device, the secondary track structure being arranged on at least one side of the main track structure, and the secondary track structure having discontinuities, varying an optically detectable surface texture of the recording medium in such a way that at least one auxiliary information is represented on the recording medium.

2. The master device according to claim 1, characterized in that the recording medium has a given surface level and the optically detectable property is a deviation from the surface level between two discontinuities which is substantially arranged in the direction of the track.

3. The master device according to claim 1, characterized in that the property which is optically detectable at the recording medium is a deviation from the surface level between two discontinuities which is substantially arranged in the direction of the track and which is substantially punctiform.

4. The master device according to claim 2, characterized in that the deviation from the surface level is an indentation.

5. The master device according to claim 2, characterized in that the deviation from the surface level is an elevation.

6. The master device according to claim 1, characterized in that the main track structure is formed at least sectionwise, but particularly continuously, in the direction of the track as a substantially homogenous surface texture.

7. The master device according to claim 1, characterized in that the main track structure has discontinuities.

8. The master device according to claim 1, characterized in that the secondary track structure has a surface texture which varies an optically detectable surface texture of a secondary track structure of the recording medium in such a way that a second auxiliary information is represented on the recording medium.

9. The master device according to claim 1, characterized in that the main track structure is formed without a track modulation.

10. The master device according to claim 1, characterized in that the main track structure is formed with a track modulation.

11. The master device according to claim 10, characterized in that the track modulation is a radial, substantially sinusoidal track modulation.

12. The master device according to claim 10, characterized in that the track modulation is a monofrequent track modulation.

13. The master device according to claim 10, characterized in that the track modulation is a track width modulation.

14. The master device according to claim 10, characterized in that the track modulation represents further auxiliary information.

15. The master device according to claim 1, characterized in that the secondary track structure is substantially arranged in a constant radial distance to the geometrical center of the main track structure.

16. The master device according to claim 1, characterized in that the secondary track structure is arranged on just one side of the main track structure.

17. A master device according to claim 1, characterized in that the secondary track structure has a variable height and/or depth.

18. A recording medium obtained by a producing method using a master device according to claim 1.

19. A device for producing a master device usable in a method for producing a recording medium, comprising a substantially spirally or concentrically running main track structure and at least one substantially spirally or concentrically running secondary track structure being formed on the master device, the secondary track structure being arranged on at least one side of the main track structure, and the secondary track structure having discontinuities, varying an optically detectable surface texture of the recording medium in such a way that at least one auxiliary information is represented on the recording medium, the device comprising:
a first optical means for recording a main track structure by means of a first light beam on a base carrier;
an electrooptical beam deflector through which the first light beam runs;
a second optical means for recording a secondary track structure by means of a second light beam on the base carrier;
the second light beam running through a second electrooptical beam deflector which adjusts a substantially constant radial distance between the center of the main track structure and the secondary track structure by means of an applied control signal;
a secondary track structure generator controlling the second light beam at least depending on a first and/or second auxiliary information;
at least one measuring camera on which the laser focus of both monochromatic light beams which is adjusted on the master is displayed; and
at least one image processing unit which calculates the position of the laser focus of the main and secondary beams on the master substantially from the image information of at least one measuring camera.

20. The device according to claim 19, characterized in that a track width modulation of the first light beam is carried out by means of the electrooptical beam deflector.

21. The device according to claim 19, characterized in that the first light beam is controlled by means of a main track generator.

22. The device according to claim 21, characterized in that the main track generator outputs a constant signal and an alternating signal for controlling the first light beam.

23. The device according to claim 21, characterized in that the main track generator outputs an analog signal for controlling the electrooptical beam deflector.

24. The device according to claim 19, characterized in that the second light beam is controlled by means of a secondary track generator.

25. The device according to claim 19, characterized in that the secondary track generator outputs a constant signal and an alternating signal for controlling the second light beam.

26. The device according to claim 19, characterized in that the secondary track generator outputs a DC and/or an AC signal for controlling the second electrooptical beam deflector.

27. The device according to claim 19, characterized in that the control signal fed to the second beam deflector is a voltage signal with a DC component.

28. The device according to claim 21, characterized in that the analog signal output by the main track generator for controlling the electrooptical beam deflector is fed to the electrooptical beam deflector.

29. A device for producing a recording medium using a master device according to claim 1.

30. A method for producing a master device according to claim 1, comprising:
exposing a base carrier with a main track structure by means of a first light beam, a photoresist being applied to the surface of the base carrier,
exposing the base carrier with a secondary track structure by means of a second light beam,
developing the exposed photoresist,
removing the unexposed photoresist from the base carrier,
applying a first metallic coating to the base carrier, and
applying a second metallic coating to the base carrier.

31. The master device of claim 3, characterized in that:
the secondary track structure has a surface texture which varies an optically detectable surface texture of a secondary track structure of the recording medium in such a way that a second auxiliary information is represented on the recording medium;
the secondary track structure is substantially arranged in a constant radial distance to the geometrical center of the main track structure;
the secondary track structure is arranged on just one side of the main track structure; and
the secondary track structure has a variable height and/or depth.

32. The master device of claim 31, characterized in that the main track structure is formed without a track modulation.

33. The master device of claim 31, characterized in that:
the main track structure is formed with a track modulation;
the track modulation is a radial, substantially sinusoidal track modulation;
the track modulation is a monofrequent track modulation;
the track modulation is a track width modulation; and
the track modulation represents further auxiliary information.

34. The master device of claim 31, characterized in that the deviation from the surface level is an indentation.

35. The master device of claim 31, characterized in that the deviation from the surface level is an elevation.

36. The master device of claim 31, characterized in that the main track structure is formed at least sectionwise, but particularly continuously, in the direction of the track as a substantially homogenous surface texture.

37. The master device of claim 31, characterized in that the main track structure has discontinuities.

38. The device of claim 20, characterized in that:
the first light beam is controlled by means of a main track generator;
the main track generator outputs a constant signal and an alternating signal for controlling the first light beam;
the main track generator outputs an analog signal for controlling the electrooptical beam deflector;
the second light beam is controlled by means of a secondary track generator;
the secondary track generator outputs a constant signal and an alternating signal for controlling the second light beam;
the secondary track generator outputs a DC and/or an AC signal for controlling the second electrooptical beam deflector;
the control signal fed to the second beam deflector is a voltage signal with a DC component; and
the analog signal output by the main track generator for controlling the electrooptical beam deflector is fed to the electrooptical beam deflector.
